(19) United States
(12) Patent Application Publication
(10) Pub. No.: US 2025/0308793 A1
(43) Pub. Date: Oct. 2, 2025

(54) MULTILAYER CERAMIC ELECTRONIC COMPONENT

(71) Applicant: Murata Manufacturing Co., Ltd., Nagaokakyo-shi (JP)

(72) Inventor: Kazunari SHIOTA, Nagaokakyo-shi (JP)

(21) Appl. No.: 18/979,767

(22) Filed: Dec. 13, 2024

(30) Foreign Application Priority Data
Mar. 27, 2024 (JP) 2024-051229

(51) Int. Cl. H01G 4/232; H01G 4/12; H01G 4/248; H01G 4/30; H01G 13/04

(52) U.S. Cl. CPC H01G 4/2325; H01G 4/1227; H01G 4/1236; H01G 4/248; H01G 4/30; H01G 13/04

(57) ABSTRACT

A multilayer ceramic electronic component includes an end surface-side base electrode layer including a lower base electrode layer with a high porosity and an upper base electrode layer with a lower porosity than the lower base electrode layer. A ratio, which is a first degree of unevenness, of a length along a profile line of the upper base electrode adjacent to an outer surface to a length of a first reference line smoothed by fitting a profile line of the upper base electrode layer adjacent to the outer surface is smaller than a ratio, which is a second degree of unevenness, of a length along a profile line of the lower base electrode layer adjacent to the multilayer body to a length of a second reference line prepared by fitting one of the end surfaces with a linear line.

### CROSS REFERENCE TO RELATED APPLICATIONS

This application claims the benefit of priority to Japanese Patent Application No. 2024-051229 filed on Mar. 27, 2024. The entire contents of this application are hereby incorporated herein by reference.

### BACKGROUND OF THE INVENTION

### 1. Field of the Invention

The present invention relates to multilayer ceramic electronic components.

### 2. Description of the Related Art

In recent years, multilayer ceramic capacitors as multilayer ceramic electronic components are required to be durable under severe environments, such as bending stress due to thermal expansion, and technology has been known which adopts a thermosetting electrically conductive resin paste for external electrodes on the multilayer ceramic capacitor. Japanese Unexamined Patent Application Publication No. H11-162771 discloses this type of technology. Japanese Unexamined Patent Application Publication No. H11-162771 discloses a multilayer ceramic capacitor including external electrodes, each including a layer structure in which an electrode layer prepared by dipping an electrically conductive paste and firing the resulting electrode layer, an electrically conductive epoxy thermosetting resin layer, a nickel plated layer, and a tin-based layer are sequentially laminated.

With the multilayer ceramic capacitor of Japanese Unexamined Patent Application Publication No. H11-162771, it is possible to reduce or prevent the occurrence of cracks in the multilayer body due to the stress relaxation by the sacrificial breakdown and deformation of the resin layer. Even in a multilayer ceramic capacitor having such a resin layer, further stress relaxation may be required. Further, improvement in moisture resistance may be required.

### SUMMARY OF THE INVENTION

Example embodiments of the present invention provide multilayer ceramic electronic components that are each able to reduce the generation of cracks in a multilayer body and improve the moisture resistance.

An example embodiment of the present invention provides a multilayer ceramic electronic component that includes a multilayer body including a plurality of laminated ceramic layers and a plurality of laminated internal conductive layers, a first main surface and a second main surface opposed to each other in a height direction, a first lateral surface and a second lateral surface opposed to each other in a width direction orthogonal or substantially orthogonal to the height direction, and a first end surface and a second end surface opposed to each other in a length direction orthogonal or substantially orthogonal to the height direction and the width direction, a first external electrode on the first end surface, and a second external electrode on the second end surface. The first external electrode includes a first end surface-side external electrode on the first end surface. The second external electrode includes a second end surface-side external electrode on the second end surface. The first end surface-side external electrode and the second end surface-side external electrode each include an end surface-side base electrode layer and an end surface-side plated layer located closer to an outer surface than the end surface-side base electrode layer is. The end surface-side base electrode layer includes a lower base electrode layer and an upper base electrode layer. The lower base electrode layer is located closer to the multilayer body than the upper base electrode layer and has a higher porosity than the upper base electrode layer. The upper base electrode layer is located closer to the outer surface than the lower base electrode layer and has a lower porosity than the lower base electrode layer. In a cross section of a plane in parallel or substantially parallel to the length direction and the height direction, a ratio, which is a first degree of unevenness, of a length measured along a profile line of the upper base electrode layer adjacent to the outer surface to the length of a first reference line smoothed by fitting a profile line of the upper base electrode layer adjacent to the outer surface is smaller than a ratio, which is a second degree of unevenness, of a length measured along a profile line of the lower base electrode layer adjacent to the multilayer body to a length of the second reference line prepared by fitting the end surface of the multilayer body with a linear line.

According to example embodiments of the present invention, it is possible to provide multilayer ceramic electronic components that are each able to reduce the generation of cracks in a multilayer body and improve the moisture resistance.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view of a multilayer ceramic capacitor of an example embodiment of the present invention.

FIG. 2 is a cross-sectional view taken along the line II-II of the multilayer ceramic capacitor of FIG. 1.

FIG. 3 is a cross-sectional view taken along the line III-III of the multilayer ceramic capacitor of FIG. 2.

FIG. 4 is a cross-sectional view taken along the line IV-IV of the multilayer ceramic capacitor of FIG. 2.

FIG. 5 is an enlarged view of a portion V of the multilayer ceramic capacitor shown in FIG. 2, and is a schematic view for explaining the porosity and degree of unevenness of an end surface-side base electrode layer of the multilayer ceramic capacitor.

FIG. 6 is a schematic view of an example of a configuration of a multilayer ceramic capacitor with a two-portion structure.

FIG. 7 is a schematic view of an example of a configuration of a multilayer ceramic capacitor with a three-portion structure.

FIG. 8 is a schematic view of an example of a configuration of a multilayer ceramic capacitor with a four-portion structure.

### DETAILED DESCRIPTION OF THE EXAMPLE EMBODIMENTS

Example embodiments of the present invention will be described in detail below with reference to the drawings.

### Example Embodiments

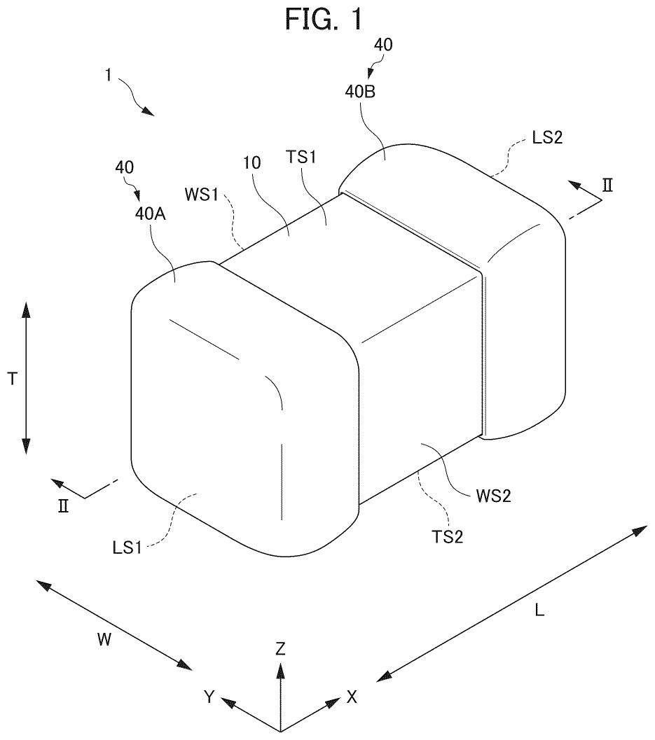

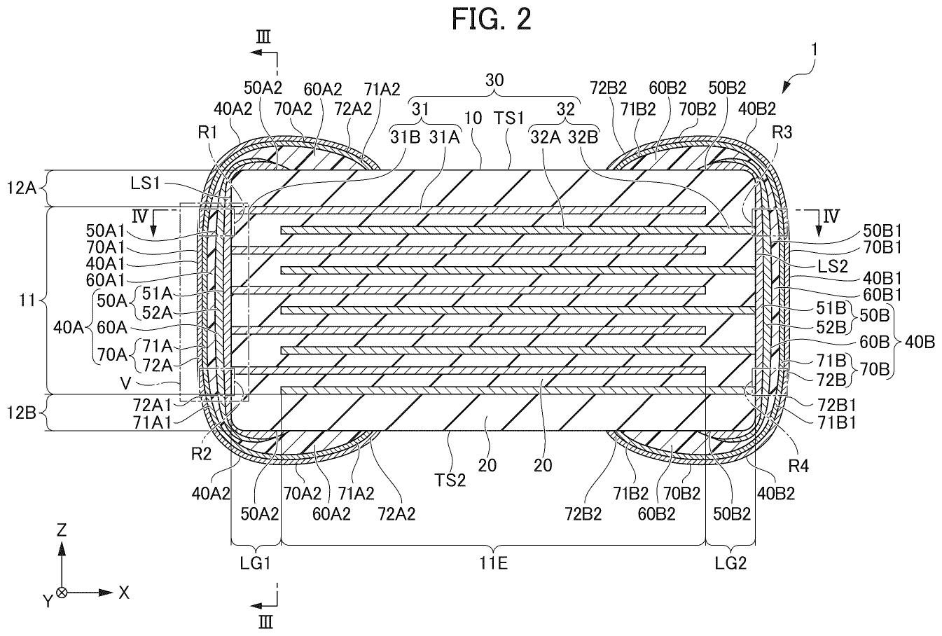

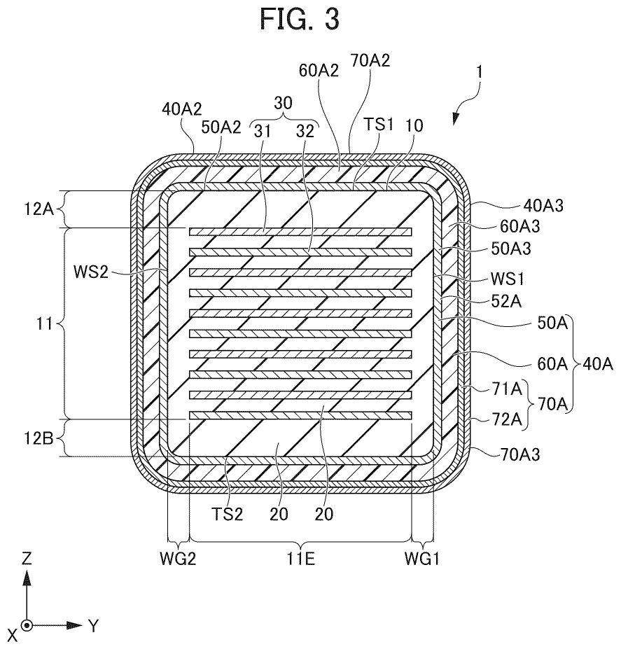

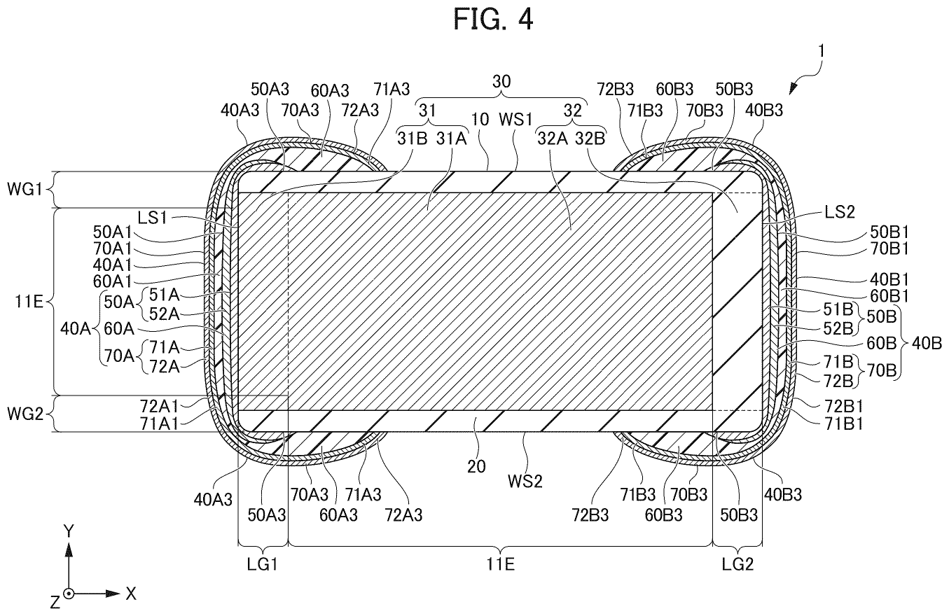

Hereinafter, a multilayer ceramic capacitor 1 defining and functioning as a multilayer ceramic electronic component according to a first example embodiment of the present invention will be described with reference to FIGS. 1 to 4. FIG. 1 is an external perspective view of a multilayer ceramic capacitor 1 of the present example embodiment. FIG. 2 is a cross-sectional view of the multilayer ceramic capacitor 1 taken along the line II-II of FIG. 1. FIG. 3 is a cross-sectional view of the multilayer ceramic capacitor 1 taken along the line III-III of FIG. 2. FIG. 4 is a cross-sectional view of the multilayer ceramic capacitor 1 taken along the line IV-IV of FIG. 2.

In the drawings, in order to explain the contents of the present invention, the drawings may be schematically simplified, and the ratio of the drawn components or the dimensions between the components may not coincide with the ratio of the dimensions described in the specification. Further, components described in the specification may be omitted in the drawings, or the number of components may be changed or omitted. For example, the number of internal electrode layers shown in FIGS. 2 and 3 is 10 for convenience of explanation, but this does not indicate the number of actual internal electrode layers 30. Further, the terms for specifying the shape and geometric conditions and the degree of the shape and geometric conditions used in the present disclosure, for example, the terms such as “parallel”, “orthogonal”, and “same” and the value of the length and angle, are not limited to the strict meaning, but are to be construed as including a range of a degree that can expect the same or similar functions.

The multilayer ceramic capacitor 1 includes a multilayer body 10 and external electrodes 40.

FIGS. 1 to 4 each show an XYZ orthogonal coordinate system. The length direction L of the multilayer ceramic capacitor 1 and the multilayer body 10 corresponds to the X direction. The width direction W of the multilayer ceramic capacitor 1 and the multilayer body 10 corresponds to the Y direction. The lamination (stacking) direction T as the height direction of the multilayer ceramic capacitor 1 and the multilayer body 10 corresponds to the Z direction. Here, the cross section shown in FIG. 2 is also referred to as an LT cross section. The cross section shown in FIG. 3 is also referred to as a WT cross section. The cross section shown in FIG. 4 is also referred to as an LW cross section.

As shown in FIGS. 1 to 4, the multilayer body 10 includes a first main surface TS1 and a second main surface TS2 which are opposed to each other in the lamination direction T, a first lateral surface WS1 and a second lateral surface WS2 which are opposed to each other in the width direction W orthogonal or substantially orthogonal to the lamination direction T, and a first end surface LS1 and a second end surface LS2 which are opposed to each other in the length direction L orthogonal or substantially orthogonal to the lamination direction T and the width direction W.

As shown in FIG. 1, the multilayer body 10 has a rectangular or substantially rectangular parallelepiped shape. The dimension in the length direction L of the multilayer body 10 is not necessarily longer than the dimension in the width direction W. The corner portions and ridge portions of the multilayer body 10 are preferably rounded. Each of the corner portions is a portion where the three surfaces of the multilayer body 10 intersect, and each of the ridge portions is a portion where the two surfaces of the multilayer body 10 intersect. In addition, unevenness or the like may be provided on a portion or the entirety of the surface of the multilayer body 10.

The dimension of the multilayer body 10 is not particularly limited, but, for example, when the dimension in the length direction L of the multilayer body 10 is defined as an L dimension, the L dimension is preferably about 0.2 mm or more and about 10 mm or less. When the dimension of the multilayer body 10 in the lamination direction T is defined as a T dimension, the T dimension is, for example, preferably about 0.1 mm or more and about 10 mm or less. When the dimension of the multilayer body 10 in the width direction W is defined as a W direction, the dimension W is, for example, preferably about 0.1 mm or more and about 10 mm or less.

As shown in FIGS. 2 and 3, the multilayer body 10 includes an inner layer portion 11, and a first main surface-side outer layer portion 12A defining and functioning as a first outer layer portion and a second main surface-side outer layer portion 12B defining and functioning as a second outer layer portion sandwiching the inner layer portion 11 in the lamination direction T.

The inner layer portion 11 includes a plurality of dielectric layers 20 defining and functioning as a plurality of ceramic layers and a plurality of internal electrode layers 30 defining and functioning as a plurality of internal conductive layers. The inner layer portion 11 includes an internal electrode layer 30 positioned closest to the first main surface TS1 to an internal electrode layer 30 positioned closest to the second main surface TS2 in the lamination direction T. In the inner layer portion 11, the plurality of internal electrode layers 30 are opposed to each other with each of the plurality of dielectric layers 20 interposed therebetween. The inner layer portion 11 is a portion that substantially defines and functions as a capacitor for generating capacitance.

The plurality of dielectric layers 20 are made of a dielectric material. The dielectric material may be, for example, a dielectric ceramic including components such as BaTiO₃, CaTiO₃, SrTiO₃, or CaZrO₃. Further, the dielectric material may be a material obtained by adding subcomponents such as, for example, a Mn compound, a Fe compound, a Cr compound, a Co compound, or a Ni compound to these main components.

The thickness of each of the plurality of dielectric layers 20 is, for example, preferably about 0.5 μm or more and about 15 μm or less. The number of laminated dielectric layers 20 is, for example, preferably 10 or more and 700 or less. The number of dielectric layers 20 is a total number of the number of dielectric layers of the inner layer portion 11 and the number of dielectric layers of the first main surface-side outer layer portion 12A and the second main surface-side outer layer portion 12B.

The plurality of internal electrode layers 30 include first internal electrode layers 31 defining and functioning as a plurality of first internal conductive layers and second internal electrode layers 32 defining and functioning as a plurality of second internal conductive layers. The plurality of first internal electrode layers 31 are provided on the plurality of dielectric layers 20. The plurality of second internal electrode layers 32 are provided on the plurality of dielectric layers 20. The plurality of first internal electrode layers 31 and the plurality of second internal electrode layers 32 are alternately provided with each of the plurality of dielectric layers 20 interposed therebetween in the lamination direction T of the multilayer body 10. One of the first internal electrode layers 31 and one of the second internal electrode layers 32 sandwich one of the dielectric layers 20.

Each of the plurality of first internal electrode layers 31 includes a first counter portion 31A opposed to each of the plurality of second internal electrode layers 32, and a first extension portion 31B extending from the first counter portion 31A toward the first end surface LS1. The first extension portion 31B is exposed at the first end surface LS1.

Each of the plurality of second internal electrode layers 32 includes a second counter portion 32A opposed to each of the plurality of first internal electrode layers 31, and a second extension portion 32B extending from the second counter portion 32A toward the second end surface LS2. The second extension portion 32B is exposed at the second end surface LS2.

In the present example embodiment, the first counter portion 31A and the second counter portion 32A are opposed to each other with the dielectric layer 20 interposed therebetween, such that a capacitance is generated, and the characteristics of the capacitor are developed.

The shapes of each of the first counter portions 31A and each of the second counter portions 32A are not particularly limited, but are preferably rectangular or substantially rectangular. However, each of the corner portions of the rectangular shape may be rounded, or each of the corner portions of the rectangular or substantially rectangular shape may include an oblique portion. The shapes of each of the plurality of first extension portions 31B and each of the plurality of second extension portions 32B are not particularly limited, but are preferably rectangular or substantially rectangular. However, each of the corner portions of the rectangular shape may be rounded, or each of the corner portions of the rectangular or substantially rectangular shape may include an oblique portion.

The dimension of each of the plurality of first counter portions 31A in the width direction W and the dimension of each of the plurality of first extension portions 31B in the width direction W may be the same, or either one of them may be smaller. The dimension of each of the plurality of second counter portions 32A in the width direction W and the dimension of each of the plurality of second extension portions 32B in the width direction W may be the same, or either one of them may be narrower.

Each of the plurality of first internal electrode layers 31 and each of the plurality of second internal electrode layers 32 are made of an appropriate electrically conductive material such as, for example, a metal such as Ni, Cu, Ag, Pd, or Au, or an alloy including at least one of these metals. When an alloy is used, each of the plurality of first internal electrode layers 31 and each of the plurality of second internal electrode layers 32 may be made of, for example, an Ag—Pd alloy.

Each of the thicknesses of the plurality of first internal electrode layers 31 and the plurality of second internal electrode layers 32 are preferably, for example, about 0.2 μm or more and about 2.0 μm or less. The total number of the plurality of first internal electrode layers 31 and the plurality of second internal electrode layers 32 is, for example, preferably 10 or more and 700 or less.

The first main surface-side outer layer portion 12A is positioned adjacent to the first main surface TS1 of the multilayer body 10. The first main surface-side outer layer portion 12A is an aggregate of a plurality of dielectric layers 20 positioned between the first main surface TS1 and the internal electrode layer 30 closest to the first main surface TS1. The dielectric layers 20 in the first main surface-side outer layer portion 12A may be the same or substantially the same as the dielectric layers 20 in the inner layer portion 11, or may be dielectric layers made of a different material.

The second main surface-side outer layer portion 12B is positioned adjacent to the second main surface TS2 of the multilayer body 10. The second main surface-side outer layer portion 12B is an aggregate of a plurality of dielectric layers 20 positioned between the second main surface TS2 and the internal electrode layer 30 closest to the second main surface TS2. The dielectric layers 20 in the second main surface-side outer layer portion 12B may be the same or substantially the same as the dielectric layers 20 in the inner layer portion 11, or may be a dielectric layer made of a different material.

The multilayer body 10 includes a counter electrode portion 11E. The counter electrode portion 11E is a portion where the first counter portions 31A of the first internal electrode layers 31 and the second counter portions 32A of the second internal electrode layers 32 are opposed to each other. The counter electrode portion 11E is a portion of the inner layer portion 11. FIG. 4 shows the range in the width direction W and the length direction L of the counter electrode portion 11E. The counter electrode portion 11E is also referred to as a capacitor effective portion.

The multilayer body 10 includes lateral surface-side outer layer portions. The lateral surface-side outer layer portion includes a first lateral surface-side outer layer portion WG1 and a second lateral surface-side outer layer portion WG2. The first lateral surface-side outer layer portion WG1 is a portion including the dielectric layers 20 positioned between the counter electrode portion 11E and the first lateral surface WS1. The second lateral surface-side outer layer portion WG2 is a portion including the dielectric layers 20 positioned between the counter electrode portion 11E and the second lateral surface WS2. FIGS. 3 and 4 each show the ranges in the width direction W of the first lateral surface-side outer layer portion WG1 and the second lateral surface-side outer layer portion WG2. The lateral surface-side outer layer portions are also each referred to as a W gap or a side gap.

The multilayer body 10 includes end surface-side outer layer portions. The end surface-side outer layer portions include a first end surface-side outer layer portion LG1 and a second end surface-side outer layer portion LG2. The first end surface-side outer layer portion LG1 is a portion including the dielectric layers 20 positioned between the counter electrode portion 11E and the first end surface LS1. The second end surface-side outer layer portion LG2 is a portion including the dielectric layers 20 positioned between the counter electrode portion 11E and the second end surface LS2. FIGS. 2 and 4 each show a range in the length direction L of the first end surface-side outer layer portion LG1 and the second end surface-side outer layer portion LG2. The end surface-side outer layer portions are also each referred to as an L gap or an end gap.

The external electrodes 40 include a first external electrode 40A on and adjacent to the first end surface LS1 and a second external electrode 40B on and adjacent to the second end surface LS2.

The first external electrode 40A is provided on the first end surface LS1. The first external electrode 40A is connected to the first internal electrode layers 31. The first external electrode 40A may also be provided on a portion of the first main surface TS1 and a portion of the second main surface TS2, and also on a portion of the first lateral surface WS1 and a portion of the second lateral surface WS2. In the present example embodiment, the first external electrode 40A includes a first end surface-side external electrode 40A1, a first main surface-side external electrode 40A2, and a first lateral surface-side external electrode 40A3. The first end surface-side external electrode 40A1 is provided on the first end surface LS1. The first main surface-side external electrode 40A2 is connected to the first end surface-side external electrode 40A1, and is provided on a portion of the first main surface TS1 and the second main surface TS2 adjacent to the first end surface LS1. The first lateral surface-side external electrode 40A3 is connected to the first end surface-side external electrode 40A1, and is provided on a portion on the first lateral surface WS1 and the second lateral surface WS2 adjacent to the first end surface LS1. Thus, the first external electrode 40A extends from the first end surface LS1 to a portion of the first main surface TS1 and a portion of the second main surface TS2, and to a portion of the first lateral surface WS1 and a portion of the second lateral surface WS2.

The second external electrode 40B is provided on the second end surface LS2. The second external electrode 40B is connected to the second internal electrode layers 32. The second external electrode 40B may also be provided on a portion of the first main surface TS1 and a portion of the second main surface TS2, and also on a portion of the first lateral surface WS1 and a portion of the second lateral surface WS2. In the present example embodiment, the second external electrode 40B includes a second end surface-side external electrode 40B1, a second main surface-side external electrode 40B2, and a second lateral surface-side external electrode 40B3. The second end surface-side external electrode 40B1 is provided on the second end surface LS2. The second main surface-side external electrode 40B2 is connected to the second end surface-side external electrode 40B1, and is provided on a portion of the first main surface TS1 and a portion of the second main surface TS2 adjacent to the second end surface LS2. The second lateral surface-side external electrode 40B3 is connected to the second end surface-side external electrode 40B1, and is provided on a portion of the first lateral surface WS1 and a portion of the second lateral surface WS2 adjacent to the second end surface LS2. Thus, the second external electrode 40B extends from the second end surface LS2 to a portion of the first main surface TS1 and a portion of the second main surface TS2, and to a portion of the first lateral surface WS1 and a portion of the second lateral surface WS2.

As described above, in the multilayer body 10, the first counter portions 31A of the first internal electrode layers 31 and the second counter portions 32A of the second internal electrode layers 32 are opposed to each other with each of the dielectric layers 20 interposed therebetween, such that a capacitance is generated. Therefore, the characteristics of the capacitor are developed between the first external electrode 40A to which the first internal electrode layers 31 are connected and the second external electrode 40B to which the second internal electrode layers 32 are connected.

The first external electrode 40A includes a first base electrode layer 50A including a metal component, a first electrically conductive resin layer 60A provided on the first base electrode layer 50A, and a first plated layer 70A provided on the first electrically conductive resin layer 60A.

The first base electrode layer 50A includes a first end surface-side base electrode layer 50A1, a first main surface-side base electrode layer 50A2, and a first lateral surface-side base electrode layer 50A3. The first end surface-side base electrode layer 50A1 includes a first lower base electrode layer 51A and a first upper base electrode layer 52A.

The first electrically conductive resin layer 60A includes a first end surface-side electrically conductive resin layer 60A1, a first main surface-side electrically conductive resin layer 60A2, and a first lateral surface-side electrically conductive resin layer 60A3.

The first plated layer 70A includes a first end surface-side plated layer 70A1, a first main surface-side plated layer 70A2, and a first lateral surface-side plated layer 70A3. The first plated layer 70A may include a two-layer structure including, for example, a first Ni plated layer 71A defining and functioning as a lower plated layer and a first Sn plated layer 72A defining and functioning as an upper plated layer. The first Ni plated layer 71A includes a first end surface-side Ni plated layer 71A1, a first main surface-side Ni plated layer 71A2, and a first lateral surface-side Ni plated layer 71A3. The first Sn plated layer 72A includes a first end surface-side Sn plated layer 72A1, a first main surface-side Sn plated layer 72A2, and a first lateral surface-side Sn plated layer 72A3.

The second external electrode 40B includes a second base electrode layer 50B including a metal component, a second electrically conductive resin layer 60B provided on the second base electrode layer 50B, and a second plated layer 70B provided on the second electrically conductive resin layer 60B.

The second base electrode layer 50B includes a second end surface-side base electrode layer 50B1, a second main surface-side base electrode layer 50B2, and a second lateral surface-side base electrode layer 50B3. The second end surface-side base electrode layer 50B1 includes a second lower base electrode layer 51B and a second upper base electrode layer 52B.

The second electrically conductive resin layer 60B includes a second end surface-side electrically conductive resin layer 60B1, a second main surface-side electrically conductive resin layer 60B2, and a second lateral surface-side electrically conductive resin layer 60B3.

The second plated layer 70B includes a second end surface-side plated layer 70B1, a second main surface-side plated layer 70B2, and a second lateral surface-side plated layer 70B3. The second plated layer 70B may include a two-layer structure including, for example, a second Ni plated layer 71B defining and functioning as a lower plated layer and a second Sn plated layer 72B defining and functioning as an upper plated layer. The second Ni plated layer 71B includes a second end surface-side Ni plated layer 71B1, a second main surface-side Ni plated layer 71B2, and a second lateral surface-side Ni plated layer 71B3. The second Sn plated layer 72B includes a second end surface-side Sn plated layer 72B1, a second main surface-side Sn plated layer 72B2, and a second lateral surface-side Sn plated layer 72B3.

Here, the basic configuration of the respective layers of the first external electrode 40A and the second external electrode 40B are the same or substantially the same. The first external electrode 40A and the second external electrode 40B are substantially plane symmetrical with respect to the LW cross section in the middle of the length direction L of the multilayer ceramic capacitor 1. Therefore, in a case where it is not necessary to particularly distinguish between the first external electrode 40A and the second external electrode 40B, the first external electrode 40A and the second external electrode 40B may be collectively referred to as an external electrode 40. Further, when it is not necessary to particularly distinguish between the first end surface-side external electrode 40A1 and the second end surface-side external electrode 40B1, the first end surface-side external electrode 40A1 and the second end surface-side external electrode 40B1 may be collectively referred to as an end surface-side external electrode 401. When it is not necessary to particularly distinguish between the first main surface-side external electrode 40A2 and the second main surface-side external electrode 40B2, the first main surface-side external electrode 40A2 and the second main surface-side external electrode 40B2 may be collectively referred to as a main surface-side external electrode 412. In addition, when it is not necessary to particularly distinguish between the first lateral surface-side external electrode 40A3 and the second lateral surface-side external electrode 40B3, the first lateral surface-side external electrode 40A3 and the second lateral surface-side external electrode 40B3 may be collectively referred to as a lateral surface-side external electrode 413. When it is not necessary to particularly distinguish between the first base electrode layer 50A and the second base electrode layer 50B, the first base electrode layer 50A and the second base electrode layer 50B are collectively referred to as a base electrode layer 50. In addition, when it is not necessary to particularly distinguish between the first end surface-side base electrode layer 50A1 and the second end surface-side base electrode layer 50B1, the first end surface-side base electrode layer 50A1 and the second end surface-side base electrode layer 50B1 may be collectively referred to as an end surface-side base electrode layer 501. In addition, when it is not particularly necessary to distinguish between the first main surface-side base electrode layer 50A2 and the second main surface-side base electrode layer 50B2, the first main surface-side base electrode layer 50A2 and the second main surface-side base electrode layer 50B2 may be collectively referred to as a main surface-side base electrode layer 502. In addition, when it is not necessary to particularly distinguish between the first lateral surface-side base electrode layer 50A3 and the second lateral surface-side base electrode layer 50B3, the first lateral surface-side base electrode layer 50A3 and the second lateral surface-side base electrode layer 50B3 may be collectively referred to as a lateral surface-side base electrode layer 503.

In addition, when it is not necessary to particularly distinguish between the first lower base electrode layer 51A and the second lower base electrode layer 51B, the first lower base electrode layer 51A and the second lower base electrode layer 51B may be collectively referred to as a lower base electrode layer 51. In addition, when it is not necessary to particularly distinguish between the first upper base electrode layer 52A and the second upper base electrode layer 52B, the first upper base electrode layer 52A and the second upper base electrode layer 52B may be collectively referred to as an upper base electrode layer 52.

When it is not necessary to particularly distinguish between the first electrically conductive resin layer 60A and the second electrically conductive resin layer 60B, the first electrically conductive resin layer 60A and the second electrically conductive resin layer 60B may be collectively referred to as an electrically conductive resin layer 60. Further, when it is not necessary to particularly distinguish between the first end surface-side electrically conductive resin layer 60A1 and the second end surface-side electrically conductive resin layer 60B1, the first end surface-side electrically conductive resin layer 60A1 and the second end surface-side electrically conductive resin layer 60B1 may be collectively referred to as an end surface-side electrically conductive resin layer 601. Further, when it is not necessary to particularly distinguish between the first main surface-side electrically conductive resin layer 60A2 and the second main surface-side electrically conductive resin layer 60B2, the first main surface-side electrically conductive resin layer 60A2 and the second main surface-side electrically conductive resin layer 60B2 may be collectively referred to as a main surface-side electrically conductive resin layer 602. In addition, when it is not necessary to particularly distinguish between the first lateral surface-side electrically conductive resin layer 60A3 and the second lateral surface-side electrically conductive resin layer 60B3, the first lateral surface-side electrically conductive resin layer 60A3 and the second lateral surface-side electrically conductive resin layer 60B3 may be collectively referred to as a lateral surface-side electrically conductive resin layer 603.

When it is not necessary to particularly distinguish between the first plated layer 70A and the second plated layer 70B, the first plated layer 70A and the second plated layer 70B may be collectively referred to as a plated layer 70. Further, when it is not necessary to particularly distinguish between the first end surface-side plated layer 70A1 and the second end surface-side plated layer 70B1, the first end surface-side plated layer 70A1 and the second end surface-side plated layer 70B1 may be collectively referred to as an end surface-side plated layer 701. In addition, when it is not necessary to particularly distinguish between the first main surface-side plated layer 70A2 and the second main surface-side plated layer 70B2, the first main surface-side plated layer 70A2 and the second main surface-side plated layer 70B2 may be collectively referred to as a main surface-side plated layer 702. In addition, when it is not necessary to particularly distinguish between the first lateral surface-side plated layer 70A3 and the second lateral surface-side plated layer 70B3, the first lateral surface-side plated layer 70A3 and the second lateral surface-side plated layer 70B3 may be collectively referred to as a lateral surface-side plated layer 703. When it is not necessary to particularly distinguish between the first Ni plated layer 71A and the second Ni plated layer 71B, the first Ni plated layer 71A and the second Ni plated layer 71B may be collectively referred to as a Ni plated layer 71. When it is not necessary to particularly distinguish between the first Sn plated layer 72A and the second Sn plated layer 72B, the first Sn plated layer 72A and the second Sn plated layer 72B may be collectively referred to as the Sn plated layer 72. When it is not necessary to particularly distinguish between the first end surface-side Ni plated layer 71A1 and the second end surface-side Ni plated layer 71B1, the first end surface-side Ni plated layer 71A1 and the second end surface-side Ni plated layer 71B1 may be collectively referred to as an end surface-side Ni plated layer 711. When it is not necessary to particularly distinguish between the first main surface-side Ni plated layer 71A2 and the second main surface-side Ni plated layer 71B2, the first main surface-side Ni plated layer 71A2 and the second main surface-side Ni plated layer 71B2 may be collectively referred to as a main surface-side Ni plated layer 712. When it is not necessary to particularly distinguish between the first lateral surface-side Ni plated layer 71A3 and the second lateral surface-side Ni plated layer 71B3, the first lateral surface-side Ni plated layer 71A3 and the second lateral surface-side Ni plated layer 71B3 may be collectively referred to as a lateral surface-side Ni plated layer 713. In addition, when it is not necessary to particularly distinguish between the first end surface-side Sn plated layer 72A1 and the second end surface-side Sn plated layer 72B1, the first end surface-side Sn plated layer 72A1 and the second end surface-side Sn plated layer 72B1 may be collectively referred to as an end surface-side Sn plated layer 721. When it is not necessary to particularly distinguish between the first main surface-side Sn plated layer 72A2 and the second main surface-side Sn plated layer 72B2, the first main surface-side Sn plated layer 72A2 and the second main surface-side Sn plated layer 72B2 may be collectively referred to as a main surface-side Sn plated layer 722. When it is not necessary to particularly distinguish between the first lateral surface-side Sn plated layer 72A3 and the second lateral surface-side Sn plated layer 72B3, the first lateral surface-side Sn plated layer 72A3 and the second lateral surface-side Sn plated layer 72B3 may be collectively referred to as a lateral surface-side Sn plated layer 723. When it is not necessary to particularly distinguish between the first end surface LS1 and the second end surface LS2, the first end surface LS1 and the second end surface LS2 may be collectively referred to as an end surface LS.

Next, the base electrode layer 50 will be described. The base electrode layer 50 includes a first base electrode layer 50A and a second base electrode layer 50B.

The first base electrode layer 50A is provided on the first end surface LS1. The first base electrode layer 50A is connected to the first internal electrode layers 31. Further, the first base electrode layer 50A may also be provided on a portion of the first main surface TS1, a portion of the second main surface TS2, a portion of the first lateral surface WS1, and a portion of the second lateral surface WS2. In the present example embodiment, the first base electrode layer 50A extends from the first end surface LS1 to a portion of the first main surface TS1 and a portion of the second main surface TS2, and to a portion of the first lateral surface WS1 and a portion of the second lateral surface WS2. More specifically, the first base electrode layer 50A is provided such that the first end surface-side base electrode layer 50A1 described above is provided on the first end surface LS1, the first main surface-side base electrode layer 50A2 described above extends from the first end surface LS1 to a portion of the first main surface TS1 and a portion of the second main surface TS2, and the first lateral surface-side base electrode layer 50A3 described above extends from the first end surface LS1 to a portion of the first lateral surface WS1 and a portion of the second lateral surface WS2.

The second base electrode layer 50B is provided on the second end surface LS2. The second base electrode layer SOB is connected to the second internal electrode layers 32. Further, the second base electrode layer SOB may also be provided on a portion of the first main surface TS1, a portion of the second main surface TS2, a portion of the first lateral surface WS1, and a portion of the second lateral surface WS2. In the present example embodiment, the second base electrode layer SOB extends from the second end surface LS2 to a portion of the first main surface TS1 and a portion of the second main surface TS2, and to a portion of the first lateral surface WS1 and a portion of the second lateral surface WS2. More specifically, the second base electrode layer SOB is provided such that the second end surface-side base electrode layer 50B1 described above is provided on the second end surface LS2, the second main surface-side base electrode layer 50B2 described above extends from the second end surface LS2 to a portion of the first main surface TS1 and a portion of the second main surface TS2, and the second lateral surface-side base electrode layer 50B3 described above extends from the second end surface LS2 to a portion of the first lateral surface WS1 and a portion of the second lateral surface WS2.

The first base electrode layer 50A and the second base electrode layer 50B of the present example embodiment are, for example, fired layers. The fired layers each preferably include a metal component and either or both of a glass component and a ceramic component. Thus, the adhesion between the multilayer body 10 and the base electrode layer 50 can be improved. The metal component includes, for example, at least one of Cu, Ni, Ag, Pd, Ag—Pd alloy, Au, and the like. The glass component includes, for example, at least one of B, Si, Ba, Mg, Al, Li, and the like. When a glass component is provided, sintering of the metal component in the base electrode layer can be promoted and advanced. The ceramic component may be a ceramic material of the same kind as the dielectric layer 20 or a ceramic material of a different kind. The ceramic component includes, for example, at least one of BaTiO₃, CaTiO₃, (Ba, Ca) TiO₃, SrTiO₃, CaZrO₃, and the like.

The fired layer is formed, for example, by coating a multilayer body with an electrically conductive paste including glass and metal and firing the resulting product. The fired layer may be obtained by simultaneously firing a multilayer chip including internal electrode layers and dielectric layers and an electrically conductive paste applied to the multilayer chip, or may be obtained by firing a multilayer chip including internal electrode layers and dielectric layers to obtain a multilayer body, and then firing the multilayer body by applying the electrically conductive paste to the multilayer body. In a case where the multilayer chip including the internal electrode layers and the dielectric layers, and the electrically conductive paste applied to the multilayer chip are simultaneously fired, the fired layer including a ceramic material instead of the glass component is preferably formed. In this case, it is particularly preferable to use the same kind of ceramic material as the dielectric layer 20 as the ceramic material to be added. The fired layer may include a plurality of layers.

The thickness in the length direction of the first end surface-side base electrode layer 50A1 positioned at the first end surface LS1 is preferably, for example, about 2 μm or more and about 220 μm or less in the middle of the first end surface-side base electrode layer 50A1 in the lamination direction T and the width direction W.

The thickness in the length direction of the second end surface-side base electrode layer 50B1 positioned at the second end surface LS2 is preferably, for example, about 2 μm or more and about 220 μm or less in the middle of the second end surface-side base electrode layer 50B1 in the lamination direction T and the width direction W.

In a case where the first base electrode layer 50A is provided also on a portion of at least one surface of the first main surface TS1 or the second main surface TS2, the thickness of the first main surface-side base electrode layer 50A2 provided on this portion in the lamination direction is preferably, for example, about 4 μm or more and about 40 μm or less in the middle in the length direction L and the width direction W of the first main surface-side base electrode layer 50A2 provided on this portion.

In a case where the first base electrode layer 50A is provided also on a portion of at least one of the first lateral surface WS1 and the second lateral surface WS2, the thickness in the width direction of the first lateral surface-side base electrode layer 50A3 provided on this portion is preferably, for example, about 4 μm or more and about 40 μm or less in the middle in the length direction L and the lamination direction T of the first lateral surface-side base electrode layer 50A3 provided on this portion.

In a case where the second base electrode layer 50B is provided on a portion of at least one surface of the first main surface TS1 or the second main surface TS2, the thickness of the second main surface-side base electrode layer 50B2 provided on this portion in the lamination direction is preferably, for example, about 4 μm or more and about 40 μm or less in the middle in the length direction L and the width direction W of the second main surface-side base electrode layer 50B2 provided on this portion.

In a case where the second base electrode layer SOB is provided also on a portion of at least one of the first lateral surface WS1 and the second lateral surface WS2, the thickness in the width direction of the second lateral surface-side base electrode layer 50B3 provided on this portion is preferably, for example, about 4 μm or more and about 40 μm or less in the middle in the length direction L and the lamination direction T of the second lateral surface-side base electrode layer 50B3 provided on this portion.

The end surface-side base electrode layer 501 includes a plurality of layers. In the present example embodiment, the end surface-side base electrode layer 501 includes, for example, a two-layer structure including a lower base electrode layer 51 and an upper base electrode layer 52.

The first lower base electrode layer 51A is provided on the first end surface LS1. The first upper base electrode layer 52A is provided on the first lower base electrode layer 51A. The first lower base electrode layer 51A is positioned closer to the multilayer body 10 than the first upper base electrode layer 52A, and the first upper base electrode layer 52A is positioned on the opposite side of the multilayer body 10 with respect to the first lower base electrode layer 51A.

The first lower base electrode layer 51A is provided on the first end surface LS1. On the other hand, the first upper base electrode layer 52A extends from the first end surface LS1 to a portion of the first main surface TS1 and a portion of the second main surface TS2, and to a portion of the first lateral surface WS1 and a portion of the second lateral surface WS2 so as to cover the first lower base electrode layer 51A. The first base electrode layer 50A is one layer of the first upper base electrode layer 52A on the first main surface TS1, the second main surface TS2, the first lateral surface WS1, and the second lateral surface WS2.

The first lower base electrode layer 51A may be provided on the first end surface LS1, but may also extend from the first end surface LS1 to a portion of the first main surface TS1 and a portion of the second main surface TS2, and to a portion of the first lateral surface WS1 and a portion of the second lateral surface WS2. In this case, the first lower base electrode layer 51A is also provided on the first main surface TS1, the second main surface TS2, the first lateral surface WS1, and the second lateral surface WS2 together with the first upper base electrode layer 52A.

The thickness of the first lower base electrode layer 51A is, for example, preferably about 5 μm or more and about 40 μm or less. The thickness of the first upper base electrode layer 52A is, for example, preferably about 5 μm or more and about 40 μm or less.

The second lower base electrode layer 51B is provided on the second end surface LS2. The second upper base electrode layer 52B is provided on the second lower base electrode layer 51B. The second upper base electrode layer 52B is positioned closer to the outer surface side than the second lower base electrode layer 51B, and the second lower base electrode layer 51B is positioned closer to the multilayer body 10 than the second upper base electrode layer 52B.

The second lower base electrode layer 51B is provided on the second end surface LS2. On the other hand, the second upper base electrode layer 52B extends from the second end surface LS2 to a portion of the first main surface TS1 and a portion of the second main surface TS2, and to a portion of the first lateral surface WS1 and a portion of the second lateral surface WS2 so as to cover the second lower base electrode layer 51B. The second base electrode layer 50B is substantially one layer of the second upper base electrode layer 52B on the first main surface TS1, the second main surface TS2, the first lateral surface WS1, and the second lateral surface WS2.

The second lower base electrode layer 51B may be provided on the second end surface LS2, but may also extend from the first end surface LS1 to a portion of the first main surface TS1 and a portion of the second main surface TS2, and to a portion of the first lateral surface WS1 and a portion of the second lateral surface WS2. In this case, the second lower base electrode layer 51B is also provided on the first main surface TS1, the second main surface TS2, the first lateral surface WS1, and the second lateral surface WS2 together with the second upper base electrode layer 52B.

The thickness of the second lower base electrode layer 51B is, for example, preferably about 5 μm or more and about 40 μm or less. The thickness of the second upper base electrode layer 52B is, for example, preferably about 5 μm or more and about 40 μm or less.

Each of the external electrodes 40 includes an electrically conductive resin layer 60 including a resin component and a metal component provided on the base electrode layer 50. The electrically conductive resin layer 60 includes a first electrically conductive resin layer 60A and a second electrically conductive resin layer 60B.

The first electrically conductive resin layer 60A covers the first base electrode layer 50A. The first electrically conductive resin layer 60A includes an end portion which is preferably in contact with the multilayer body 10. The end portion of the first electrically conductive resin layer 60A indicates a portion of the first electrically conductive resin layer 60A closer to the second end surface LS2 than the first base electrode layer 50A in the length direction L. In the present example embodiment, the first electrically conductive resin layer 60A is provided such that the first end surface-side electrically conductive resin layer 60A1 described above is provided on the first end surface LS1, the first main surface-side electrically conductive resin layer 60A2 described above extends from the first end surface LS1 to a portion of the first main surface TS1 and a portion of the second main surface TS2, and the first lateral surface-side electrically conductive resin layer 60A3 described above extends from the first end surface LS1 to a portion of the first lateral surface WS1 and a portion of the second lateral surface WS2.

The second electrically conductive resin layer 60B covers the second base electrode layer 50B. The second electrically conductive resin layer 60B includes an end portion which is preferably in contact with the multilayer body 10. The end portion of the second electrically conductive resin layer 60B indicates a portion of the second electrically conductive resin layer 60B closer to the first end surface LS1 than the second base electrode layer 50B in the length direction L. In the present example embodiment, the second electrically conductive resin layer 60B is provided such that the second end surface-side electrically conductive resin layer 60B1 described above is provided on the second end surface LS2, the second main surface-side electrically conductive resin layer 60B2 described above extends from the second end surface LS2 to a portion of the first main surface TS1 and a portion of the second main surface TS2, and the second lateral surface-side electrically conductive resin layer 60B3 described above extends from the second end surface LS2 to a portion of the first lateral surface WS1 and a portion of the second lateral surface WS2.

The thickness in the length direction L of the first end surface-side electrically conductive resin layer 60A1 positioned adjacent to the first end surface LS1 is preferably, for example, about 10 μm or more and about 200 μm or less in the middle of the first end surface-side electrically conductive resin layer 60A1 in the lamination direction T and the width direction W.

The thickness in the length direction L of the second end surface-side electrically conductive resin layer 60B1 positioned adjacent to the second end surface LS2 is preferably, for example, about 10 μm or more and about 200 μm or less in the middle of the second end surface-side electrically conductive resin layer 60B1 in the lamination direction T and the width direction W.

In a case where the first electrically conductive resin layer 60A is also provided on a portion of the first main surface TS1 and a portion of the second main surface TS2, the thickness in the lamination direction T of the first main surface-side electrically conductive resin layer 60A2 provided on this portion is preferably, for example, about 10 μm or more and about 200 μm or less in the middle of the first main surface-side electrically conductive resin layer 60A2 provided on this portion in the length direction L and the width direction W.

In a case where the first electrically conductive resin layer 60A is also provided on a portion of the first lateral surface WS1 and a portion of the second lateral surface WS2, the thickness in the width direction W of the first lateral surface-side electrically conductive resin layer 60A3 provided on this portion is preferably, for example, about 10 μm or more and about 200 μm or less in the middle of the first lateral surface-side electrically conductive resin layer 60A3 provided on this portion in the length direction L and the lamination direction T.

In a case where the second electrically conductive resin layer 60B is also provided on a portion of the first main surface TS1 and a portion of the second main surface TS2, the thickness of the second main surface-side electrically conductive resin layer 60B2 provided on this portion in the lamination direction T is preferably, for example, about 10 μm or more and about 200 μm or less in the middle of the second main surface-side electrically conductive resin layer 60B2 provided on this portion in the length direction L and the width direction W.

In a case where the second electrically conductive resin layer 60B is also provided on a portion of the first lateral surface WS1 and a portion of the second lateral surface WS2, the thickness in the width direction W of the second lateral surface-side electrically conductive resin layer 60B3 provided on this portion is preferably, for example, about 10 μm or more and about 200 μm or less in the middle of the second lateral surface-side electrically conductive resin layer 60B3 provided on this portion in the length direction L and the lamination direction T.

The electrically conductive resin layer 60 is provided on the base electrode layer 50. The plated layer 70 covers the electrically conductive resin layer 60. The plated layer 70 includes, for example, a Ni plated layer 71 and a Sn plated layer 72.

The electrically conductive resin layer 60 includes a resin portion and an electrically conductive filler dispersed in the resin portion.

The resin portion of the electrically conductive resin layer 60 may include, for example, at least one of various known thermosetting resins such as epoxy resin, phenoxy resin, phenol resin, urethane resin, silicone resin, and polyimide resin. Among them, epoxy resins excelling in heat resistance, moisture resistance, adhesiveness and the like are one of the more preferable suitable resins. The resin portion of the electrically conductive resin layer 60 preferably includes a curing agent together with the thermosetting resin. When an epoxy resin is used as the base resin, the curing agent of the epoxy resin may be any of various known compounds such as, for example, phenolic, amine-based, acid anhydride-based, imidazole-based, active ester-based, and amideimide-based compounds.

Since the electrically conductive resin layer 60 includes such a resin portion, it is more flexible than the base electrode layer 50 made of, for example, a plating film or a fired product of a metal component and a glass component. Therefore, even when a physical impact or shock caused by thermal cycling acts on the multilayer ceramic capacitor 1, the electrically conductive resin layer 60 defines and functions as a buffer layer. Accordingly, it is possible for the electrically conductive resin layer 60 to reduce or prevent the generation of cracks in the multilayer ceramic capacitor 1.

The electrically conductive filler is dispersed in the resin portion in a substantially uniform distribution. The electrically conductive filler mainly maintains the conductivity of the electrically conductive resin layer 60. Specifically, when the plurality of electrically conductive fillers are brought into contact with each other, an electric current-carrying path is provided inside the electrically conductive resin layer 60, and the base electrode layer 50 and the plated layer 70 are electrically connected to each other.

The metal of the electrically conductive filler may be, for example, Ag alone, an alloy including Ag, or a metal powder with Ag coated on the surface of the metal powder. Ag is suitable as electrode materials because of having the lowest specific resistance among metals. Since Ag is a noble metal, it hardly oxidizes and the weatherability is high. Therefore, the metal powder of Ag is suitable as the electrically conductive filler. When a metal powder coated with Ag is used, for example, Cu, Ni, Sn, Bi or an alloy powder including them is preferably used as the metal powder.

Further, the electrically conductive filler may be formed by, for example, subjecting Cu or Ni to an antioxidant treatment. The electrically conductive filler may be a metal powder obtained by coating the surface of the metal powder with, for example, Sn, Ni, or Cu. When a metal powder coated with Sn, Ni, or Cu is used, the metal powder is, for example, preferably Ag, Cu, Ni, Sn, or Bi or an alloy powder thereof.

The shape of the electrically conductive filler is not particularly limited. The electrically conductive filler may have a spherical shape, a flat shape, or the like. Further, it is preferable to use a combination of metal powders having a spherical shape and a flat shape.

The average particle diameter of the electrically conductive filler may be, for example, about 0.3 μm or more and about 10 μm or less.

The average particle diameter of the electrically conductive filler included in the electrically conductive resin layer 60 is calculated by using a laser diffraction particle size measurement method based on ISO 13320, regardless of the shape of the electrically conductive filler.

The plated layer 70 includes a first plated layer 70A and a second plated layer 70B.

The first plated layer 70A covers the first electrically conductive resin layer 60A. In the present example embodiment, the first plated layer 70A extends from the first end surface LS1 to a portion of the first main surface TS1 and a portion of the second main surface TS2, and to a portion of the first lateral surface WS1 and a portion of the second lateral surface WS2. More specifically, the first plated layer 70A is provided such that the first end surface-side plated layer 70A1 described above is provided on the first end surface LS1, the first main surface-side plated layer 70A2 described above extends from the first end surface LS1 to a portion of the first main surface TS1 and a portion of the second main surface TS2, and the first lateral surface-side plated layer 70A3 described above extends from the first end surface LS1 to a portion of the first lateral surface WS1 and a portion of the second lateral surface WS2.

The second plated layer 70B covers the second electrically conductive resin layer 60B. In the present example embodiment, the second plated layer 70B extends from the first end surface LS1 to a portion of the first main surface TS1 and a portion of the second main surface TS2, and to a portion of the first lateral surface WS1 and a portion of the second lateral surface WS2. More specifically, the second plated layer 70B is provided such that the second end surface-side plated layer 70B1 described above is provided on the second end surface LS2, the second main surface-side plated layer 70B2 described above extends from the second end surface LS2 to a portion of the first main surface TS1 and a portion of the second main surface TS2, and the second lateral surface-side plated layer 70B3 described above extends from the second end surface LS2 to a portion of the first lateral surface WS1 and a portion of the second lateral surface WS2.

The plated layer 70 preferably has a two-layer structure of, for example, a Ni plated layer 71 and a Sn plated layer 72. The first Sn plated layer 72A is preferably provided on the first Ni plated layer 71A, and the second Sn plated layer 72B is preferably provided on the second Ni plated layer 71B. In the present example embodiment, the first end surface-side Ni plated layer 71A1 and the first end surface-side Sn plated layer 72A1 are provided on the first end surface LS1, the first main surface-side Ni plated layer 71A2 and the first main surface-side Sn plated layer 72A2 extend from the first end surface LS1 to a portion of the first main surface TS1 and a portion of the second main surface TS2, and the first lateral surface-side Ni plated layer 71A3 and the first lateral surface-side Sn plated layer 72A3 described above extend from the first end surface LS1 to a portion of the first lateral surface WS1 and a portion of the second lateral surface WS2. Similarly, the second end surface-side Ni plated layer 71B1 and the second end surface-side Sn plated layer 72B1 are provided on the second end surface LS2, the second main surface-side Ni plated layer 71B2 and the second main surface-side Sn plated layer 72B2 extend from the second end surface LS2 to a portion of the first main surface TS1 and a portion of the second main surface TS2, and the second lateral surface-side Ni plated layer 71B3 and the second lateral surface-side Sn plated layer 72B3 described above extend from the second end surface LS2 to a portion of the first lateral surface WS1 and a portion of the second lateral surface WS2.

The Ni plated layer 71 prevents the base electrode layer 50 and the electrically conductive resin layer 60 from being eroded by solder when the multilayer ceramic capacitor 1 is mounted. The Sn plated layer 72 improves wettability of solder when mounting the multilayer ceramic capacitor 1. This facilitates mounting of the multilayer ceramic capacitor 1.

The thicknesses of the first Ni plated layer 71A and the first Sn plated layer 72A are, for example, preferably about 1 μm or more and about 15 μm or less.

The thicknesses of the second Ni plated layer 71B and the second Sn plated layer 72B are, for example, preferably about 1 μm or more and about 15 μm or less.

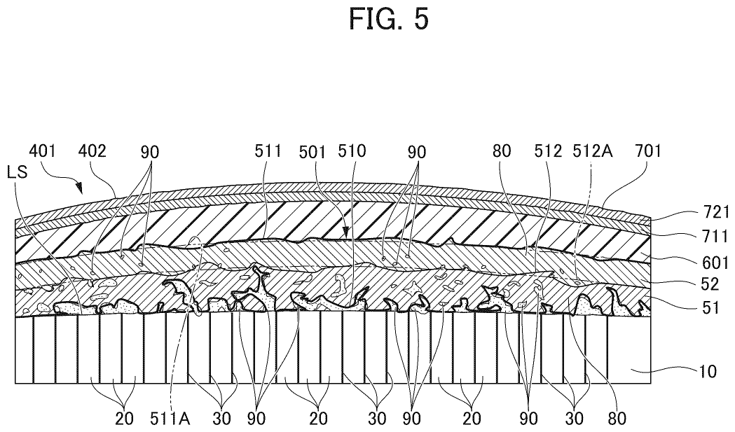

FIG. 5 is an enlarged view of a portion V of the multilayer ceramic capacitor 1 shown in FIG. 2, and is a schematic diagram for explaining the porosity and degree of unevenness of an end surface-side base electrode layer 501 of the multilayer ceramic capacitor 1. As described above, since the basic configurations of the first end surface-side external electrode 40A1 and the second end surface-side external electrode 40B1 are the same or substantially the same, these electrodes are collectively described as the end surface-side external electrode 401 with reference to FIG. 5. The same applies to other layers of the first end surface-side external electrode 40A1 and the second end surface-side external electrode 40B1.

As shown in FIG. 5, the end surface-side external electrode 401 includes an end surface-side base electrode layer 501, an end surface-side electrically conductive resin layer 601, and an end surface-side plated layer 701. In the following description, the outer surface of the end surface-side Sn plated layer 721, which is the outermost surface of the end surface-side external electrode 401, is referred to as an outer surface 402.

The end surface-side base electrode layer 501 is provided on the end surface LS of the multilayer body 10. The end surface-side base electrode layer 501 includes a lower base electrode layer 51 and an upper base electrode layer 52. The lower base electrode layer 51 is provided on the end surface LS of the multilayer body 10. The upper base electrode layer 52 is closer to the outer surface 402 than the lower base electrode layer 51. In the present example embodiment, the end surface-side electrically conductive resin layer 601 is provided on the upper base electrode layer 52. In the following description, a surface of the lower base electrode layer 51 facing the end surface LS of the multilayer body 10 is referred to as a multilayer body-side surface. This multilayer body-side surface is referred to as a multilayer body-side profile line 510 in the LT cross section shown in FIG. 5. A surface of the upper base electrode layer 52 located adjacent to the outer surface 402 of the upper base electrode layer 52 is referred to as an outer surface-side surface. This outer surface-side surface is referred to as an outer surface-side profile line 511 in the LT cross section shown in FIG. 5.

The outer surface-side profile line 511 is a line or plane of the surface in contact with the end surface-side electrically conductive resin layer 601 and is also a line or plane of a surface adjacent to the end surface-side electrically conductive resin layer. Further, in the LT cross section shown in FIG. 5, the boundary portion between the lower base electrode layer 51 and the upper base electrode layer 52 is indicated as a boundary line 512.

Each of the lower base electrode layer 51 and the upper base electrode layer 52 includes a metal portion 80 and a plurality of voids 90 existing in the metal portion 80.

The metal portion 80 includes, for example, at least one metal component of Cu, Ni, Ag, Pd, Ag—Pd alloy, Au, and the like included in the fired layer of the base electrode layer 50. The plurality of voids 90 are dispersed in the metal portion 80.

The plurality of voids 90 each indicate a portion in which a void is provided without the presence of metal, and includes a portion in which a glass component or a ceramic component is included in the void. For example, each of the plurality of voids 90 may include, for example, a glass component including Ba or Si. Each of the plurality of voids 90 relieves a stress generated by a force applied to the external electrode 40. The porosity indicates the presence ratio of the voids 90 in the base electrode layer 50, i.e., the presence ratio of the non-metal portion.

The lower base electrode layer 51 is a region having a high porosity in the end surface-side base electrode layer 501. The upper base electrode layer 52 is a region having a low porosity in the end surface-side base electrode layer 501. The porosity of the lower base electrode layer 51 is higher than the porosity of the upper base electrode layer 52.

The porosity of the lower base electrode layer 51 is, for example, preferably about 20% or more and about 50% or less. On the other hand, the porosity of the upper base electrode layer 52 is, for example, preferably less than about 20%.

In the cross section (LT cross section) of the plane in parallel to the length direction and the height direction shown in FIG. 5 in the multilayer ceramic capacitor 1 according to the present example embodiment, the first degree of unevenness of the profile line 511 of the upper base electrode layer 52 adjacent to the outer surface is smaller than the second degree of unevenness of the profile line 510 of the lower base electrode layer 51 adjacent to the multilayer body 10.

More specifically, in the LT cross section of the multilayer ceramic capacitor 1 according to the present example embodiment, the first degree of unevenness, which is the ratio of the length LA2 measured along the profile line 511 of the upper base electrode layer 52 adjacent to the outer surface to the length LA1 of the first reference line 511A smoothed by fitting the profile line 511 of the upper base electrode layer 52 adjacent to the outer surface (LA2/LA1), is smaller than the second degree of unevenness, which is the ratio of the length LB2 measured along the profile line 510 of the lower base electrode layer 51 adjacent to the multilayer body 10 to the length LB1 of the second reference line prepared by fitting the end surface LS of the multilayer body with a linear line (LB2/LB1).

With such a configuration, it is possible to reduce the generation of cracks in the multilayer body 10 and improve the moisture resistance.

In addition, as shown in FIG. 5, when the profile line 511 has a gently curving curved shape as a whole, the first reference line 511A can be obtained as an approximate curve obtained by fitting the profile line 511 with a quadratic function. When the profile line 511A has a generally straight line as a whole, the profile line 511 can be obtained as an approximate straight line obtained by fitting the profile line 511 as a whole. In addition, the second reference line is a line generally corresponding to the end surface LS of the multilayer body 10 in the LT cross section shown in FIG. 5.

As described above, the first degree of unevenness of the profile line 511 of the upper base electrode layer 52 having a low porosity adjacent to the outer surface is small. On the other hand, the second degree of unevenness of the profile line 510 of the lower base electrode layer 51 having a high porosity adjacent to the multilayer body 10 is large.

The ratio LA2/LA1, which is the first degree of unevenness, of the length LA2 measured along the profile line 511 of the upper base electrode layer 52 adjacent to the outer surface to the length LA of the first reference line 511A is, for example, preferably larger than about 1 and about 1.4 or less. The ratio LB2/LB1, which is the second degree of unevenness, of the length LB2 measured along the profile line 510 of the lower base electrode layer 51 adjacent to the multilayer body 10 to the length LB1 of the second reference line is, for example, preferably about 1.6 or more and about 2.7 or less. The ratio B/A of the first degree of unevenness to the second degree of unevenness is, for example, preferably about 0.75 or less, and more preferably about 0.3 or more and about 0.75 or less.

Further, in the LT cross section, the first degree of unevenness of the profile line 511 of the upper base electrode layer 52 adjacent to the outer surface may be smaller than a third degree of unevenness of the boundary line 512 between the lower base electrode layer 51 and the upper base electrode layer 52. Further, in the LT cross section, the second degree of unevenness of the profile line 510 of the lower base electrode layer 51 adjacent to the multilayer body 10 may be larger than the third degree of unevenness of the boundary line 512 indicating the boundary between the lower base electrode layer 51 and the upper base electrode layer 52.

More specifically, in the LT cross section, the ratio LA2/LA1, which is the first degree of unevenness, of the length LA2 measured along the profile line 511 of the upper base electrode layer 52 adjacent to the outer surface to the length LA1 of the first reference line 511A smoothed by fitting the profile line 511 of the upper base electrode layer 52 adjacent to the outer surface, may be smaller than the ratio LC2/LC1, which is the third degree of unevenness, of the length LC2 measured along the boundary line 512 indicating the boundary between the lower base electrode layer 51 and the upper base electrode layer 52 to the length LC1 of the third reference line 512A smoothed by fitting the boundary line 512 indicating the boundary between the lower base electrode layer 51 and the upper base electrode layer 52. Further, in the LT cross section, the ratio LB2/LB1, which is the second degree of unevenness, of the length LB2 measured along the profile line 510 of the lower base electrode layer 51 adjacent to the multilayer body 10 to the length LB1 of the second reference line prepared by fitting the end surface LS of the multilayer body with a linear line, may be larger than the ratio LC2/LC1, which is the third degree of unevenness, of the length LC2 measured along the boundary line 512 indicating the boundary between lower base electrode layer 51 and the upper base electrode layer 52 to the length LC1 of the third reference line 512A smoothed by fitting the boundary line 512 indicating the boundary between the lower base electrode layer 51 and the upper base electrode layer 52.

In addition, as shown in FIG. 5, when the boundary line 512 has a gently curving curved shape as a whole, the third reference line 512A can be obtained as an approximate curve obtained by fitting the boundary line 512 with a quadratic function. When the boundary line 512 is a generally straight line as a whole, the third reference line 512A can be obtained as an approximate straight line obtained by fitting the boundary line 512 as a whole.

As described above, it is preferable that the relationship among the three degrees of unevenness above is defined as: (the first degree of unevenness of the profile line 511 of the upper base electrode layer 52 adjacent to the outer surface)<(the third degree of unevenness of the boundary line 512 indicating the boundary between the lower base electrode layer 51 and the upper base electrode layer 52)<(the second degree of unevenness of the profile line 510 of the lower base electrode layer 51 adjacent to the multilayer body 10). With appropriate unevenness on the boundary surface between the lower base electrode layer 51 and the upper base electrode layer 52, they are strongly connected to each other such that the lower base electrode 50 is substantially configured integrally while the first degree of unevenness of the profile line 511 of the upper base electrode layer 52 having a low porosity adjacent to the outer surface is made small. On the other hand, the second degree of unevenness of the profile line 510 of the lower base electrode layer 51 having a high porosity adjacent to the multilayer body 10 is made high such that it is possible for the lower base electrode layer 50 to include a plurality of functions such that reduce the generation of cracks in the multilayer body 10 and improve moisture resistance.

When the dimension in the length direction of the multilayer ceramic capacitor 1 including the multilayer body 10 and the external electrode 40 is defined as an L dimension, the L dimension is, for example, preferably about 0.2 mm or more and about 10 mm or less. When the dimension of the multilayer ceramic capacitor 1 in the lamination direction is defined as a T dimension, the T dimension is, for example, preferably about 0.1 mm or more and about 10 mm or less. The dimension of the multilayer ceramic capacitor 1 in the width direction is defined as a W dimension. The W dimension is, for example, preferably about 0.1 mm or more and about 10 mm or less.

Next, an example of a method of measuring various parameters such as the porosity and degree of unevenness of the lower base electrode layer 51 and the upper base electrode layer 52 in the present example embodiment will be described.

First, the multilayer ceramic capacitor 1 is polished from the first lateral surface WS1 or the second lateral surface WS2 to a position about ½ of the dimension in the width direction W. Then, the LT cross section in the middle position in the width direction W of the multilayer ceramic capacitor 1 is exposed. Next, the LT cross section exposed by polishing is observed by SEM. Specifically, a portion including the base electrode layer 50 in the LT cross section is imaged as a reflected electron image. In the reflected electron image, the difference in resistance value is reflected as contrast, the metal portion 80 is relatively white, and the voids 90 appear darker than the metal portion 80. In addition, the imaging magnification is set to, for example, about 2000 times, and a portion of the base electrode layer 50 in the reflected electron image is set as an analysis target range.

A total of four reflected electron images of two locations of the first base electrode layer 50A and two locations of the second base electrode layer 50B are obtained. The reflected electron image acquisition position is set so as to include both the lower base electrode layer 51 and the upper base electrode layer 52. In FIG. 2, four positions of the reflected electron image acquisition are denoted by R1, R2, R3, and R4. R1 is a portion closest to the first main surface TS1 of the first base electrode layer 50A in contact with the inner layer portion 11 of the multilayer body 10. R2 is a portion closest to the second main surface TS2 of the first base electrode layer 50A in contact with the inner layer portion 11 of the multilayer body 10. R3 is a portion closest to the first main surface TS1 of the second base electrode layer 50B in contact with the inner layer portion 11 of the multilayer body 10. R4 is a portion closest to the second main surface TS2 of the second base electrode layer 50B in contact with the inner layer portion 11 of the multilayer body 10. The lengths of R1, R2, R3, and R4 in the lamination direction T are all approximately 80 μm, for example.

In the base electrode layer 50, the four regions corresponding to the respective reflected electron image acquisition positions R1, R2, R3, and R4 are each likely to be a structural singularity and have a high degree of influence on crack resistance. Therefore, the state of the base electrode layer 50 in these portions is important from the viewpoint of crack resistance. In addition, these four regions are usually regions where the end portion of the internal electrode layer 30 and the outer surface of the external electrode layer are closest to each other, and are important from the viewpoint of moisture resistance.

The acquired reflected electron image is binarized by the image analysis software “WinROOF (available from Mitani Corporation)” to identify the metal portion 80 and a plurality of voids 90 existing in the metal portion 80. The binary image is used to calculate various parameters such as the areas of the individual voids 90 existing in the lower base electrode layer 51 and the upper base electrode layer 52. Further, the porosity of each of the lower base electrode layer 51 and the upper base electrode layer 52 is calculated.

The areas of the voids 90 are calculated based on a binary image obtained by binarizing the reflected electron image. When the area of each of the voids 90 is, for example, less than about 2.0 μm², it may be noise rather than the void 90. Therefore, in order to exclude the influence of noise, voids 90 of less than about 2.0 μm² are excluded from the analysis target.

Based on the areas of the analysis target range and the voids 90, the presence ratio of the voids 90 in each of the lower base electrode layer 51 and the upper base electrode layer 52 are calculated by the following equation (1).

Porosity (%)=(area of non-metal portion/area of analysis target)×100 (1)

For each of the four analysis target ranges (R1, R2, R3, and R4), the presence ratio of the voids 90 is calculated. Then, the average value is calculated as the porosity in the present example embodiment.

As described above, the measurement target range for calculating the average area of the voids 90 is a set of analysis target ranges at the above-described four locations (R1, R2, R3, and R4). Specifically, the measurement target range is a portion adjacent to the first main surface TS1 and a portion adjacent to the second main surface TS2 of the first base electrode layer 50A and the second base electrode layer 50B, which are in contact with the inner layer portion 11 of the multilayer body 10. More specifically, the measurement target range of the first base electrode layer 50A and the second base electrode layer 50B is a portion of, for example, about 80 μm from the boundary portion between the inner layer portion 11 and the first main surface-side outer layer portion 12A of the multilayer body 10 toward the middle of the multilayer body 10 in the lamination direction, and a portion of, for example, about 80 μm from the boundary portion between the inner layer portion 11 and the second main surface-side outer layer portion 12B of the multilayer body 10 toward the middle of the multilayer body 10 in the lamination direction.

Next, the measurement of the degree of unevenness will be described. The degree of unevenness can be calculated using, for example, image analysis or the like from a digital microscope image.

Each of the profile lines and the boundary lines can be extracted from images by using image analysis software. Further, each reference line can be obtained by fitting the profile lines thus extracted, etc. The length of each line can also be obtained by the image analysis software. Each degree of unevenness is calculated based on the length of each line thus obtained. The degree of unevenness is calculated within the range in the height direction corresponding to the inner layer portion 11.

Next, an example of a method of manufacturing the multilayer ceramic capacitor 1 of the present example embodiment will be described. The method of manufacturing the multilayer ceramic capacitor 1 of the present example embodiment is not limited as long as it satisfies the above-described requirements. However, a preferred manufacturing method includes the following processes. The details of each process will be described below.

A dielectric sheet for forming the dielectric layer 20 and an electrically conductive paste for forming the internal electrode layer 30 are prepared. The dielectric sheet and the electrically conductive paste for forming the internal electrodes include a binder and a solvent. The binder and the solvent may be well known.

The electrically conductive paste for forming the internal electrode layer 30 is printed on the dielectric sheet in a predetermined pattern by, for example, screen printing or gravure printing. Thus, a dielectric sheet including a pattern of the first internal electrode layer 31 and a dielectric sheet including a pattern of the second internal electrode layer 32 are prepared.

By laminating a predetermined number of dielectric sheets on which patterns of internal electrode layers are not printed, a portion defining and functioning as the first main surface-side outer layer portion 12A adjacent to the first main surface TS1 is formed. A dielectric sheet on which the pattern of the first internal electrode layer 31 is printed and a dielectric sheet on which the pattern of the second internal electrode layer 32 is printed are sequentially laminated thereon, such that a portion defining and functioning as the inner layer portion 11 is formed. A predetermined number of dielectric sheets on which patterns of internal electrode layers are not printed are laminated on a portion functioning as the inner layer portion 11, such that a portion defining and functioning as the second main surface-side outer layer portion 12B adjacent to the second main surface TS2 is formed. Thus, a multilayer sheet is manufactured.

The multilayer sheet is pressed in the lamination direction by, for example, a hydrostatic press or the like to form a multilayer block.

By cutting the multilayer block into a predetermined size, the multilayer chip is cut out. At this time, the corner portions and ridge portions of the multilayer chip may be rounded by barrel polishing or the like.

The multilayer chip is fired to form the multilayer body 10. The firing temperature depends on the materials of the dielectric layer 20 and the internal electrode layer 30, but is, for example, preferably about 900° C. or higher and about 1400° C. or lower.

An electrically conductive paste defining and functioning as the base electrode layer 50 is applied to both end surfaces of the multilayer body 10. In the present example embodiment, the base electrode layer 50 is a fired layer. An electrically conductive paste including a glass component and a metal is applied to the multilayer body 10 by a method such as, for example, dipping. Then, firing treatment is performed to form the base electrode layer 50. The temperature of the firing treatment at this time is, for example, preferably about 700° C. or higher and about 950° C. or lower.

In the present example embodiment, in order to form the end surface-side base electrode layer 501 with a two-layer structure, the base electrode layer 50 is formed by dividing into the process of applying the first layer defining and functioning as the lower base electrode layer 51 and the process of applying the second layer defining and functioning as the upper base electrode layer 52.

In the process of forming the first layer, the first lower base electrode layer 51A is formed by performing dipping to immerse the first end surface LS1 of the multilayer body 10 in the electrically conductive paste layer including, for example, Cu having large particles. Since the first lower base electrode layer 51A only needs to be formed on the first end surface LS1 of the multilayer body 10, the paste coating thickness is set to be thin in the coating process. Similarly, by immersing the second end surface LS2 of the multilayer body 10 in the electrically conductive paste layer made of, for example, Cu having large particles, the second lower base electrode layer 51B is formed. Since the second lower base electrode layer 51B only needs to be formed on the second end surface LS2 of the multilayer body 10, the paste coating thickness is set to be thin in the coating process.

By the process of forming the first layer, the lower base electrode layer 51, which is a Cu electrode having large particles, is provided only on the end surface LS of the multilayer body 10, and the bonding property between the base electrode layer 50 and the internal electrode layer 30 is ensured. In addition, the lower base electrode layer 51 causes stress relaxation due to the voids 90 existing in the lower base electrode layer 51, thereby improving the bending strength.

In the process of forming the second layer, the first upper base electrode layer 52A is formed by performing dipping to immerse the multilayer body 10 in the electrically conductive paste layer including small particles of, for example, Cu. In this coating process, the paste coating thickness required to secure the length of the extending portion is set. The length of the extending portion refers to the length of the extending portion of the first upper base electrode layer 52A. The extending portion extends from the end surface LS to the main surface TS and the lateral surface WS in the length direction L of the multilayer body 10.

Dipping is performed so that the first upper base electrode layer 52A extends from the first end surface LS1 to a portion of the first main surface TS1 and a portion of the second main surface TS2. At the same time, it is preferable that the dipping is performed so that the first upper base electrode layer 52A also extends to a portion of the first lateral surface WS1 and a portion of the second lateral surface WS2. Similarly, dipping is performed so that the second upper base electrode layer 52B extends from the second end surface LS2 to a portion of the first main surface TS1 and a portion of the second main surface TS2. At this time, it is preferable that the dipping is performed so that the second upper base electrode layer 52B also extends to a portion of the first lateral surface WS1 and a portion of the second lateral surface WS2.

By the process of forming the second layer, the upper base electrode layer 52, which is a Cu electrode having relatively small particles, is provided adjacent to the outer surface 402 of the lower base electrode layer 51. In the process of forming the second layer, the coating may be performed twice or more in order to adjust the thickness of the end surface LS. The upper base electrode layer 52 improves the denseness of the base electrode layer 50 adjacent to the outer surface 402 and maintains moisture resistance.

Through the process of forming the first layer and the process of forming the second layer, the upper base electrode layer 52 of the second layer is provided on the lower base electrode layer 51 of the first layer, and the main surface TS and the lateral surface WS of the multilayer body 10 are coated with the upper base electrode layer 52. Further, by controlling the process of forming the first layer such that the lower base electrode layer 51 is not formed or hardly formed on the main surface TS and the lateral surface WS of the multilayer body 10, the portion covering the main surface TS and the lateral surface WS becomes substantially one layer of the upper base electrode layer 52. This makes it possible to make the main surface TS and the lateral surface WS of the base electrode layer 50 thinner.

The multilayer chip before firing and the electrically conductive paste applied to the multilayer chip may be fired simultaneously. In this case, the fired layer is preferably formed by firing a ceramic material added instead of the glass component. At this time, it is particularly preferable to use the same kind of ceramic material as the dielectric layer 20 as the ceramic material to be added. In this case, the electrically conductive paste is applied to the multilayer chip before firing, and the multilayer chip and the electrically conductive paste applied to the multilayer chip are fired at the same time to form the multilayer body 10 in which the fired layer is formed.

Next, the electrically conductive resin layer 60 is formed. The electrically conductive resin layer 60 may be formed on the surface of the base electrode layer 50 or may be formed directly on the multilayer body 10. In the present example embodiment, the electrically conductive resin layer 60 is formed on the surface of the base electrode layer 50.

First, an electrically conductive resin paste in which an electrically conductive filler is dispersed in a thermosetting resin as a base resin defining and functioning as a resin portion is prepared. The electrically conductive resin paste is produced by stirring and mixing the thermosetting resin and the electrically conductive filler. Accordingly, the electrically conductive filler is dispersed and present in a uniform distribution in the electrically conductive resin paste. Here, the thermosetting resin is, for example, an epoxy resin. The electrically conductive filler is, for example, Ag metal powder.

Then, the electrically conductive resin paste is applied on the base electrode layer 50 by, for example, a dipping method, and heat treatment is performed at a temperature of, for example, about 200° C. or higher and about 550° C. or lower. Thus, the resin portion is thermally cured to form the electrically conductive resin layer 60. At this time, the atmosphere during the heat treatment is, for example, preferably an N₂ atmosphere. In order to prevent scattering of the resin and to prevent oxidation of various metal components, the oxygen concentration is, for example, preferably about 100 ppm or less.

In the present example embodiment, the dipping is performed so that the first electrically conductive resin layer 60A extends from the first end surface LS1 to a portion of the first main surface TS1 and a portion of the second main surface TS2. Further, the dipping is performed so that the second electrically conductive resin layer 60B extends from the second end surface LS2 to a portion of the first main surface TS1 and a portion of the second main surface TS2. At this time, the dipping is preferably performed so that the first electrically conductive resin layer 60A extends to a portion of the first lateral surface WS1 and a portion of the second lateral surface WS2. Further, it is preferable that the dipping is performed so that the second electrically conductive resin layer 60B extends to a portion of the first lateral surface WS1 and a portion of the second lateral surface WS2.

Then, a plated layer 70 is formed on the surface of the electrically conductive resin layer 60. In the present example embodiment, for example, the Ni plated layer 71 and the Sn plated layer 72 are formed on the electrically conductive resin layer 60. The Ni plated layer 71 and the Sn plated layer 72 are sequentially formed by using an electrolytic plating method, for example. As a plating method, for example, barrel plating is preferably used.

The multilayer ceramic capacitor 1 is manufactured by the manufacturing processes described above.

According to the multilayer ceramic capacitor 1 of the present example embodiment, the following advantageous effects are obtained.

In recent years, ceramic electronic components such as multilayer ceramic capacitors have been used in a more severe environment. For example, electronic components used in mobile devices such as mobile phones and portable music players are required to withstand impacts when dropped. Specifically, it is necessary to prevent the electronic component from falling off from the mounting board or to prevent cracks from occurring in the electronic component even when a drop impact is received.

Electronic components for use in vehicle-mounted equipment such as, for example, an Electronic Control Unit (ECU) are required to withstand thermal cycling shock. Specifically, it is necessary to prevent cracks from occurring in the electronic component even when the electronic component is subjected to bending stress generated by thermal expansion and contraction of the mounting substrate due to thermal cycling.

However, in the multilayer ceramic electronic component such as Japanese Unexamined Patent Application Publication No. H11-162771, the stress in the base electrode layer provided on the end surface of the multilayer body is not stipulated.

In example embodiments of the present invention, the end surface-side base electrode layer 501 includes a two-layer structure in which the lower base electrode layer 51, which is a portion having a high porosity, is provided adjacent to the multilayer body 10, which is the element body, and the upper base electrode layer 52, which is a portion having a low porosity, is provided adjacent to the plated layer 70, which is the plating side. By providing the lower base electrode layer 51 having a high porosity on the side adjacent to the multilayer body 10, stress relaxation due to the voids 90 existing at the interface between the multilayer body 10 and the external electrode 40 occurs, and the bending strength is improved. Further, since the upper base electrode layer 52 having a low porosity is provided adjacent to the plated layer 70, a moisture intrusion suppressing effect is achieved, and the sealing property of the external electrode 40 can be ensured.

Further, by providing the upper base electrode layer 52 having a low porosity on the side adjacent to the plated layer 70, the unevenness of the profile line 511 of the outer surface-side surface, which is the surface of the end surface-side base electrode layer 501 adjacent to the outer surface 402, is reduced, and the smoothness of the profile line 511 of the outer surface-side surface 511 is improved. In the present example embodiment, since the interface between the end surface-side electrically conductive resin layer 601 and the end surface-side base electrode layer 501 is smooth, the contact between the end surface-side base electrode layer 501 and the metal filler of the electrically conductive resin layer is improved, and therefore, the ESR is improved. In addition, even in a configuration in which a plated layer is formed directly on the end surface-side base electrode layer 501 that does not include the electrically conductive resin layer, the smoothness improves the plating property.

A multilayer ceramic capacitor 1 (the multilayer ceramic electronic component) according to an example embodiment of the present invention includes the multilayer body 10 including the plurality of laminated dielectric layers 20 (the ceramic layers 20) and the plurality of laminated internal electrode layers 30 (the internal conductive layer 30), the first main surface TS1 and the second main surface TS2 opposed to each other in the lamination direction T, the first lateral surface WS1 and the second lateral surface WS2 opposed to each other in the width direction W orthogonal or substantially orthogonal to the lamination direction T, and the first end surface LS1 and the second end surface LS2 opposed to each other in the length direction L orthogonal or substantially orthogonal to the lamination direction T and the width direction W, the plurality of first internal electrode layers 31 (the first internal conductive layers 31) on the plurality of dielectric layers 20 and exposed at the first end surface LS1, the plurality of second internal electrode layers 32 (the second internal conductive layers 32) on the plurality of dielectric layers 20 and exposed at the second end surface LS2, the first external electrode 40A on the first end surface LS1, and the second external electrode 40B on the second end surface LS2. The first external electrode 40A includes the first end surface-side external electrode 40A1 on the first end surface LS1. The second external electrode 40B includes the second end surface-side external electrode 40B1 on the second end surface LS2. The first end surface-side external electrode 40A1 and the second end surface-side external electrode 40B1 each include the end surface-side base electrode layer 501 and the end surface-side plated layer 701, which is located closer to the outer surface than the end surface-side base electrode layer 501 is. The end surface-side base electrode layer 501 includes the lower base electrode layer 51 and the upper base electrode layer 52. The lower base electrode layer 51 is located closer to the multilayer body 10 than the upper base electrode layer 52 and has a higher porosity than the upper base electrode layer 52. The upper base electrode layer 52 is located closer to the outer surface than the lower base electrode layer 51 and has a lower porosity than the lower base electrode layer 51. In the cross section of the plane in parallel to the length direction and the height direction, the ratio, which is the first degree of unevenness, of the length measured along the profile line of the upper base electrode layer adjacent to the outer surface to the length of the first reference line smoothed by fitting the profile line of the upper base electrode layer adjacent to the outer surface is smaller than the ratio, which is the second degree of unevenness, of the length measured along the profile line of the lower base electrode layer adjacent to the multilayer body to the length of the second reference line prepared by fitting the end surface of the multilayer body with a linear line.

Thus, it is possible to provide multilayer ceramic electronic components that are each able to reduce the occurrence of cracks in a multilayer body and improve the moisture resistance.

In a multilayer ceramic capacitor 1 according to an example embodiment of the present invention, the first end surface-side external electrode 40A1 and the second end surface-side external electrode 40B1 each further include the end surface-side electrically conductive resin layer 601 on the upper base electrode layer 52, and the end surface-side plated layer 701 is on the end surface-side electrically conductive resin layer 601.

With such a configuration, since the electrically conductive resin layer is provided between the base electrode layer 50 and the plated layer 70, when stress due to impact at the time of dropping or bending stress generated by thermal expansion and contraction of the mounting board due to thermal cycling occurs, it is possible for the epoxy-based thermosetting resin layer to release the stress transmitted to the mounting board due to the distortion of the mounting board, thereby making it possible to reduce or prevent the occurrence of cracks in the ceramic electronic component body. It is also possible to achieve a reduction in ESR.

In a multilayer ceramic capacitor 1 according to an example embodiment of the present invention, the lower base electrode layer 51 has a porosity of about 20% or more and about 50% or less, and the upper base electrode layer 52 has a porosity of less than about 20%.

With such a configuration, it is possible to provide a multilayer ceramic electronic component having a stress relaxation function and moisture resistance in a balanced manner.

In a multilayer ceramic capacitor 1 according to an example embodiment of the present invention, a ratio of the first degree of unevenness to the second degree of unevenness is about 0.75 or less.

With such a configuration, it is possible to provide a multilayer ceramic electronic component having a good balance between smoothness and high deflection strength that has a good influence on the layers provided on the base electrode layer 50. The good influence caused by the smoothness is an improvement in ESR when a layer provided on the base electrode layer is a resin layer, and improvement in plating property when a layer is a plated layer.

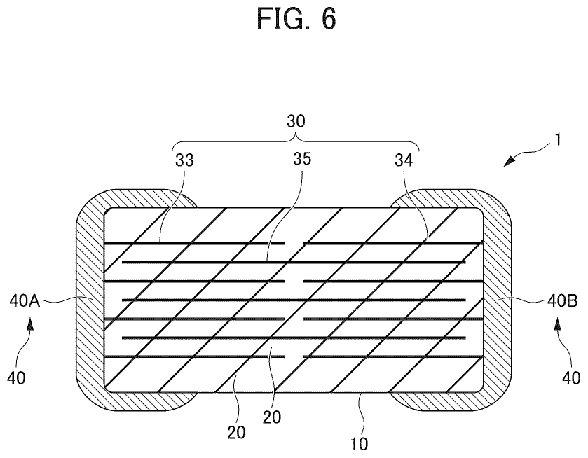

The configuration of the multilayer ceramic capacitor 1 is not limited to the configurations shown in FIGS. 1 to 5. For example, the multilayer ceramic capacitor 1 may be a multilayer ceramic capacitor including a two-portion structure, a three-portion structure, or a four-portion structure as shown in FIGS. 6, 7, and 8.

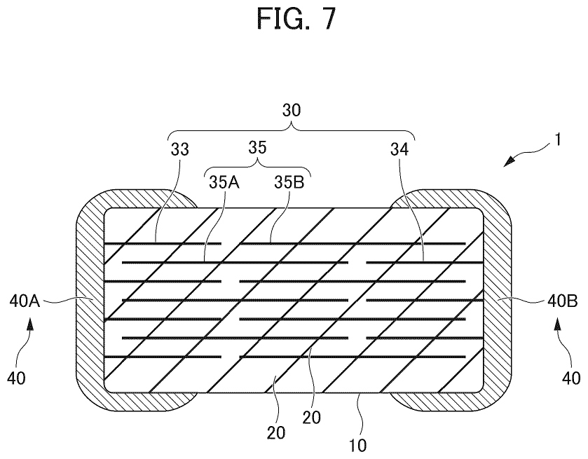

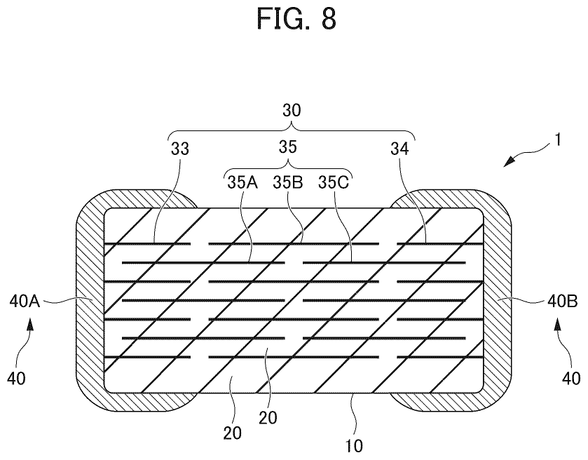

The multilayer ceramic capacitor 1 shown in FIG. 6 is a multilayer ceramic capacitor 1 including a two-portion structure, and includes, as internal electrode layers 30, floating internal electrode layers 35 which are not exposed at either the first end surface LS1 or the second end surface LS2 in addition to the first internal electrode layers 33 and the second internal electrode layers 34. The multilayer ceramic capacitor 1 shown in FIG. 7 is a multilayer ceramic capacitor 1 including a three-portion structure including first floating internal electrode layers 35A and second floating internal electrode layers 35B as floating internal electrode layers 35. The multilayer ceramic capacitor 1 shown in FIG. 8 is a multilayer ceramic capacitor 1 including a four-portion structure including first floating internal electrode layers 35A, second floating internal electrode layers 35B, and third floating internal electrode layers 35C as floating internal electrode layers 35. As described above, by providing the floating internal electrode layers 35 as the internal electrode layers 30, the multilayer ceramic capacitor 1 has a structure in which the counter electrode portions are divided into a plurality of portions. With such a configuration, a plurality of capacitor components are provided between the opposing internal electrode layers 30, and these capacitor components are connected in series. Therefore, the voltages applied to the respective capacitor components are reduced, and thus it is possible to improve the pressure resistance of the multilayer ceramic capacitor 1. In addition, the multilayer ceramic capacitor 1 of the present example embodiment may include a multiple-portion structure of four or more.

The multilayer ceramic capacitor 1 may be, for example, a two-terminal multilayer ceramic capacitor including two external electrodes or of a multi-terminal multilayer ceramic capacitor including a large number of external electrodes.

In the above-described example embodiments, as the multilayer ceramic electronic component, a multilayer ceramic capacitor in which the dielectric layers 20 made of dielectric ceramic are used as a ceramic layer is exemplified. However, the multilayer ceramic electronic component of the present invention is not limited thereto. For example, the ceramic electronic component can be applied to various multilayer ceramic electronic components such as a piezoelectric component using a piezoelectric ceramic as a ceramic layer, a thermistor using a semiconductor ceramic as a ceramic layer, and an inductor using a magnetic ceramic as a ceramic layer. Piezoelectric ceramic includes PZT (lead zirconate titanate) ceramic, semiconductor ceramic includes spinel ceramic, and magnetic ceramic includes ferrite ceramic.

The present invention is not limited to example embodiments of the present invention, and can be appropriately modified and applied without departing from the gist of the present invention. The present invention also includes combinations of two or more of the individual desirable configurations described in the above example embodiments.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a multilayer body including a plurality of laminated ceramic layers and a plurality of laminated internal conductive layers, a first main surface and a second main surface opposed to each other in a height direction, a first lateral surface and a second lateral surface opposed to each other in a width direction orthogonal or substantially orthogonal to the height direction, and a first end surface and a second end surface opposed to each other in a length direction orthogonal or substantially orthogonal to the height direction and the width direction;
a first external electrode on the first end surface; and
a second external electrode on the second end surface; wherein
the first external electrode includes a first end surface-side external electrode on the first end surface;
the second external electrode includes a second end surface-side external electrode on the second end surface;
the first end surface-side external electrode and the second end surface-side external electrode each include an end surface-side base electrode layer and an end surface-side plated layer located closer to an outer surface than the end surface-side base electrode layer is;
the end surface-side base electrode layer includes a lower base electrode layer and an upper base electrode layer, the lower base electrode layer being located closer to the multilayer body than the upper base electrode layer and having a higher porosity than the upper base electrode layer, and the upper base electrode layer being located closer to the outer surface than the lower base electrode layer and having a lower porosity than the lower base electrode layer; and
in a cross section of a plane in parallel or substantially parallel to the length direction and the height direction, a ratio, which is a first degree of unevenness, of a length measured along a profile line of the upper base electrode layer adjacent to the outer surface to a length of a first reference line smoothed by fitting the profile line of the upper base electrode layer adjacent to the outer surface is smaller than a ratio, which is a second degree of unevenness, of a length measured along a profile line of the lower base electrode layer adjacent to the multilayer body to a length of a second reference line prepared by fitting one of the end surfaces of the multilayer body with a linear line.

2. The multilayer ceramic electronic component according to claim 1, wherein
the first end surface-side external electrode and the second end surface-side external electrode each include an end surface-side electrically conductive resin layer on the upper base electrode layer; and
the end surface-side plated layer is on the end surface-side electrically conductive resin layer.

3. The multilayer ceramic electronic component according to claim 1, wherein the lower base electrode layer has a porosity of about 20% or more and about 50% or less, and the upper base electrode layer has a porosity of less than about 20%.

4. The multilayer ceramic electronic component according to claim 1, wherein a ratio of the first degree of unevenness to the second degree of unevenness is about 0.75 or less.

5. The multilayer ceramic electronic component according to claim 1, wherein
a dimension in the length direction of the multilayer body is about 0.2 mm or more and about 10 mm or less;
a dimension of the multilayer body in the lamination direction is about 0.1 mm or more and about 10 mm or less; and
a dimension of the multilayer body in the width direction is about 0.1 mm or more and about 10 mm or less.

6. The multilayer ceramic electronic component according to claim 1, wherein each of the plurality of ceramic layers includes BaTiO₃, CaTiO₃, SrTiO₃, or CaZrO₃ as a main component.

7. The multilayer ceramic electronic component according to claim 6, wherein each of the plurality of ceramic layers includes a Mn compound, a Fe compound, a Cr compound, a Co compound, or a Ni compound as a subcomponent.

8. The multilayer ceramic electronic component according to claim 1, wherein a thickness of each of the plurality of ceramic layers is about 0.5 μm or more and about 15 μm or less.

9. The multilayer ceramic electronic component according to claim 1, wherein a number of the plurality of ceramic layers is 10 or more and 700 or less.

10. The multilayer ceramic electronic component according to claim 1, wherein each of the plurality of internal conductive layers includes Ni, Cu, Ag, Pd, or Au, or an alloy including at least one of Ni, Cu, Ag, Pd, or Au.

11. The multilayer ceramic electronic component according to claim 1, wherein a thickness of each of the plurality of internal conductive layers is about 0.2 μm or more and about 2.0 μm or less.

12. The multilayer ceramic electronic component according to claim 1, wherein a number of the plurality of internal conductive layers is 10 or more and 700 or less.

13. The multilayer ceramic electronic component according to claim 1, wherein the end surface-side plated layer includes a Ni plated layer and a Sn plated layer on the Ni plated layers.

14. The multilayer ceramic electronic component according to claim 2, wherein a thickness of the end surface-side electrically conductive resin layer is about 10 μm or more and about 200 μm or less.

15. The multilayer ceramic electronic component according to claim 1, wherein the end surface-side electrically conductive resin layer includes a resin portion including epoxy resin, phenoxy resin, phenol resin, urethane resin, silicone resin, or polyimide resin.

16. The multilayer ceramic electronic component according to claim 15, wherein the resin portion of the end surface-side electrically conductive resin layer includes a curing agent.

17. The multilayer ceramic electronic component according to claim 16, wherein the curing agent includes phenolic, amine-based, acid anhydride-based, imidazole-based, active ester-based, or amideimide-based compounds.
